(19) United States
(12) Patent Application Publication
(10) Pub. No.: US 2020/0258492 A1
(43) Pub. Date: Aug. 13, 2020

(54) NOISE SUPPRESSION DEVICE

(71) Applicant: PATTISON SAND COMPANY, LLC, Clayton, IA (US)

(72) Inventor: Howard W. Wood, Earlville, IA (US)

(21) Appl. No.: 16/271,566

(22) Filed: Feb. 8, 2019

(51) Int. Cl. G10K 11/162; E21F 17/00; E21B 12/00; B25F 5/02

(52) U.S. Cl. CPC G10K 11/162; E21F 17/00; B25D 17/12; B25F 5/02; E21B 12/00

(57) ABSTRACT

A Noise Suppression device is provided for pneumatic noise producing tools, including jack leg drills, jack hammers and other hand-operated machinery. This device comprises an expansion chamber substantially enclosing a sound source of the noise producing tool. The chamber comprises a lining and, preferably, an acoustic panel to provide sound absorption. In one embodiment, the device also includes a skirting to direct the noise away from the tool. The lining of the expansion chamber may comprise a material such as Thinsulate® old filter casing, or other noise absorbing material to absorb at least a portion of the sound, reducing the level of noise emanating from the drill during operation. The device preferably includes an outer shell or protective surface which may comprise a durable material such as HDPE plastic and comprises an inner surface. The device not only reduces muffler noise but also the noise from the tool itself.

### FIELD OF THE INVENTION

The present invention relates to noise reduction and management for drilling tools. More specifically, the present invention provides a noise suppression device for use with hand operated machinery including, at least, drills, generally, and with jackleg drills used in mining operations particularly.

### BACKGROUND

Mining, Digging, blasting, drilling, bolting and other activities intended to release and recover natural resources trapped underground have been employed for decades. Various precious jewels, minerals, and petroleum products have been harvested and recovered using these techniques. And, over time, the methods and tools used to recover such resources have been devised, refined, improved, and changed.

Early recovery included digging with hand tools. As time passed, miners developed techniques that included sluicing and devised machines that provided more power and more reach for digging and injecting fluids to encourage production. Petroleum products were among the materials mined.

One of the devices used in the mining process is the manually-applied power jackleg drill comprising a hard-surfaced rotary bit. The jackleg drill was developed during the industrial revolution and changed the way mining was accomplished. It provided a much more powerful, hand operated tool than was previously available. The jackleg drill, generally, can be set up and operated by one person. It typically comprises a cylinder, motor, and a throttle. A head, a chuck and a drill rod associated with the cylinder provides means to drill. The rod is, generally, one of 2, 4, 6 or 8 feet in length and often ⅞ inch hex. The leg is pneumatic to provide means to lift or lower the jack. A water line and a water valve can be provided to reduce dust production and provide cooling. The “leg” portion of its name refers to the hydraulic leg which facilitates adjustment in the height of the drill to be changed and to provide pressure against the rock face which is being drilled. Although technological advancements to the drill have been made, its basic design is still very much in use today.

Jackleg drills are used in a variety of mining operations, including those related to minerals, jewels, petroleum. Some drills are designed to be used both horizontally and vertically; some drills are specific to one or the other. Specifically, the drills are commonly used to drill into a rock face in order to position dynamite or other blasting material deep within its surface. The dynamite is then exploded and the material examined for the desired ore or mineral. The drill may also be used to place other equipment in the mine walls as needed such as support bolts. By using a hydraulic version of the drill (employing water or other fluid during the drilling process), miners were able to reduce the amount of dangerous airborne particles to which they were exposed during the mining process. In short, both the early versions and the hydraulic version of the jackleg drill made mining operations much safer for those involved which also increased the productivity of the workers who were trained to use them. However, the jackleg drill—whether hydraulic or not—and whether employed vertically or horizontally—still poses a danger to its operators in terms of noise. This danger is also posed to other workers that use hand operated tools comprising motors/engines and/or are intended for uses that drill, grind, hammer, or chisel.

To address the damage to workers resulting from the noise produced by the jack leg drills and other noise-emanating hand operated tools, regulations pertaining to the allowed exposure to noise in terms of decibels have been implemented and required. A drill operator wears a device that measures decibels over time and, when the limit is reached, that operator must cease operating the drill for a specified number of hours. Generally, this means other operators must be standing by to take over. And, because each task differs thereby effecting the rate at which noise exposure accumulates, the use of simple shift changes for operators is not always practical. Particularly, relevant regulations provide limitations for exposure. Based upon Federal Regulations sound power doubles every 5 dBA—it is a logarithmic scale. The table below exemplifies this principal:

| dBA | Dose |
|---|---|
| 85 | 50% |
| 90 | 100% |
| 95 | 200% |
| 100 | 400% |
| 105 | 800% |
| 110 | 1,600% |
| 115 (Max) | 3,200% |

MSHA and OSHA have established exposure/dosage limits and add a 2 dB error factor before citations are issued. So there is no possibility of the standard not being exceeded. For example:
Action Level=85 dBA+2 dBA Error Factor=87 dBA (66% Dose)
Permissible Exposure Limit=90 dBA+2 dBA Error Factor=92 dBA (132% Dose)

The actual sound doubling rate for human hearing is 3 dBA. For this reason, both MSHA and OSHA define “effective” controls as any control or combination of controls which results in a 3 dBA reduction in sound or noise. Because the jack leg drill operation produces high sound density there is a need to manage exposure to noise such that an operator can operate the drill during his full shift without being exposed to more than the restricted amount of noise. Several inventions have addressed noise exposure. For example:

U.S. Pat. No. 6,427,782 provides a device for noise management for machines having hard surfaced rotary bits. It comprises a complex arrangement of perforated plastic, fiber glass liner and a shell and is associated with the drill so as to catch sound from the exhaust outlet of the drill. This device is relatively complex including all of the following for noise reduction; cushions 304D, perforated plastic 304C, fiber glass 304A, outer shell 304, and liner 304B.

U.S. Pat. No. 6,089,346 discloses use of acoustic barrier material within its housing and a frustoconical shape attached at the exhaust outlet. The muffler includes an inlet and an outlet and catches noise at the jack's exhaust port.

While both of the aforementioned devices help to manage noise that is “exhausted” with the machine's exhaust, they do not address noise that emanates from parts of the drill other than the exhaust system. There is, therefore, additional noise produced that is not being addressed.

A report by the US Department of the Interior entitled “Noise Reduction of a Pneumatic Rock Drill” published in 1975 and provided a well-described context of various testing of devices employed for noise abatement and related findings. None of the devices described by that report suggest the present invention. Further, although several more recent patents covering noise management devices were located, none suggest the present invention. Specifically, among the located patent documents are US Patent Application Nos. 2009/0090530 and 2009/0294211 which disclose simple muffler devices. Another device for muffling noise of a pneumatic device was presented by U.S. Pat. No. 6,089,346. The '346 discloses the use of acoustic barrier material within its housing and a frustoconical shape; the device is associated with the exhaust outlet, catching noise at the jack leg drill's exhaust port.

### SUMMARY

The inventive noise suppression device is very user friendly and designed to manage noise exposure to miners operating jackleg or other drills or noise-producing tools which are partially or completely hand operated. The device preferably includes an outer shell or cover which may comprise a durable material such as HDPE plastic and comprises an inner surface. The device not only reduces muffler noise but also the noise from the tool itself.

Generally, the device is a cover designed to “catch”/muffle sound as it exits a machine whether the noise exits through the machine's exhaust or other portions of the machine. The noise suppression device is designed to substantially encase portions of the drill machine in order to achieve the noise reduction objective. The device may comprise a conical end through which a drilling rod extends for drilling and through which a portion of the sound travels. With minor adjustment to the design, the device may be used with horizontal or vertical drilling operations, or with tools that employ different attachments that also product high noise levels. The present invention improves over other noise management devices such as earphones for the operator or a muffler associated with the exhaust on the drill. In general, the present invention comprises an improvement that reduces noise emanating from more than simply the exhaust of the drill's motor.

The present invention is a noise suppression device that fits over at least a portion of the body of the drill (or other tool) (which body may comprise a cylinder, controls, motor, and drill mechanics). The noise suppression device includes a first end (to fit over at least a portion of the rod of the drill or another attachment), noise suppressors such as an acoustic panel or echo absorber, at least one liner comprising noise reducing material such as rubber or mesh, a second end, and, usually, a skirt. The inventive noise suppression device installs in minutes and is lightweight. It can just as easily be removed for other applications of the too. In-mine testing shows that the device markedly reduces the rate of noise exposure, increasing time that its operator can work within the governmental guidelines pertaining to noise exposure. In short, the device measurably improves labor efficiency in the mine or other environment where noise-emanating hand-operated tools are employed, allowing miners to work a full shift without over exposure to noise.

### BRIEF DESCRIPTION OF DRAWINGS

FIG. 1 is a side cross section view of a first embodiment of an inventive noise suppression device for use in vertical drilling;

FIG. 2 is an end view from the second end of the first embodiment of the inventive noise suppression device for use in vertical drilling;

FIG. 3 is an end view from the first end of the first embodiment of the inventive noise suppression device for use in vertical drilling;

FIG. 4 is a cross-section view of the first embodiment of the inventive noise suppression device of the present invention showing the first and second rings;

FIG. 5 is a cross section showing the shell, the first ring and the second ring of the first embodiment of the inventive noise suppression device;

FIG. 6 is a side view of a second embodiment of the inventive noise suppression device;

FIG. 7 is a bottom or second endview of the second embodiment of the noise suppression device;

FIG. 8 is an end view from the first end of the second embodiment of the inventive noise suppression device;

FIG. 9 is a cross section view of the second embodiment showing the shell;

FIG. 10 is a cross section showing the shell of the second embodiment;

FIG. 11 is a side view of a third embodiment of the inventive noise suppression device;

FIG. 12 is a cross-sectional, top view of the third embodiment;

FIG. 13 is a side cross-sectional view of the third embodiment;

FIG. 14 is an end view from a first end of the third embodiment of the inventive noise suppression device;

FIG. 15 is an end view from a second end of the third embodiment of the inventive noise suppression device;

FIG. 16 is a side view of a jack leg drill.

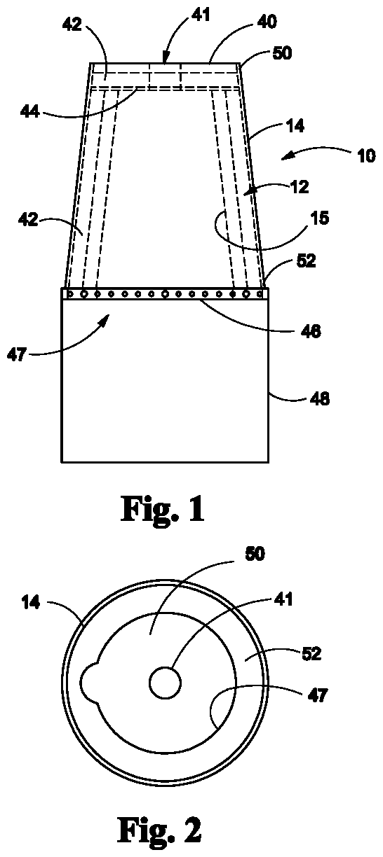

### DETAILED DESCRIPTION

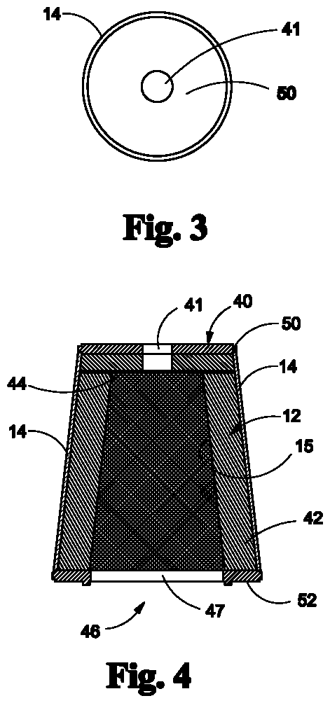

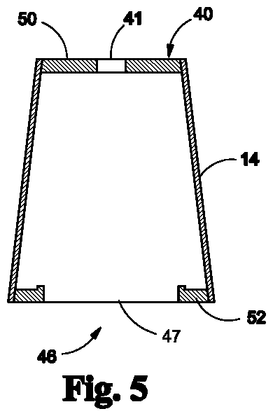

Clearly, noise is a problem with hand-operated drilling machinery and other hand-operated motorized tools and has been addressed in various ways with varying levels of success including ear protection for the user, and mufflers associated with the exhaust of the machinery. The present invention will be described herein by reference numbers associated with figures. Two embodiments of the invention are presented as noise suppression devices 10 and 100. The invention is a noise suppression device 10, 100 for use with a drilling device 5 and works by “muffling” and “catching” noise using sound dampening materials 12 substantially covered or encased in an outer shell 14. The shell 14 also comprises an inner surface 15 and surrounds or partially surrounds a noise source 16 rather than simply accepting the noise from an exhaust outlet 20, as the prior art teaches. The noise source may comprise a motor 16 and a drill rod 18. (The noise source may, instead, comprise another hand-operated motorized drilling or other tool. Specifically, a first embodiment of the present invention is a noise suppression device 10 that fits over and fully or substantially surrounds at least a portion of a body 22 of the drilling device 5 (which device may comprise a cylinder 30, controls, drill mechanics 34, and, the rod 18). The device may comprise an outer shape which may be conical. (See FIGS. 2 and 3). The noise suppression device 10 includes a first end 40, (to fit over at least a portion of the rod of the drill 18), at least one and preferably more than one sound suppressors 42 such as an acoustic panel or echo absorber, at least one liner 44 comprising noise reducing material such as rubber or mesh, a second end 46 and, usually, a skirt or skirting 48 designed to facilitate sound dissipation. The first embodiment of the noise suppression device 10 may comprise a first ring 50 at the first end 40 forming a first opening 41. Further, or alternatively, the noise suppression device 10 may also comprise a second ring 52 at the second end 46 forming a second opening 47. In the first embodiment, the first opening 41 is smaller than the second opening 47 and/or the first end 40 may be smaller than the second end 46 thereby providing a conical shape. In an embodiment, the first ring 50 and the second ring 52 are covered and separated by at least one of a sound suppressor 42, and mesh liner 44 extending substantially therebetween.

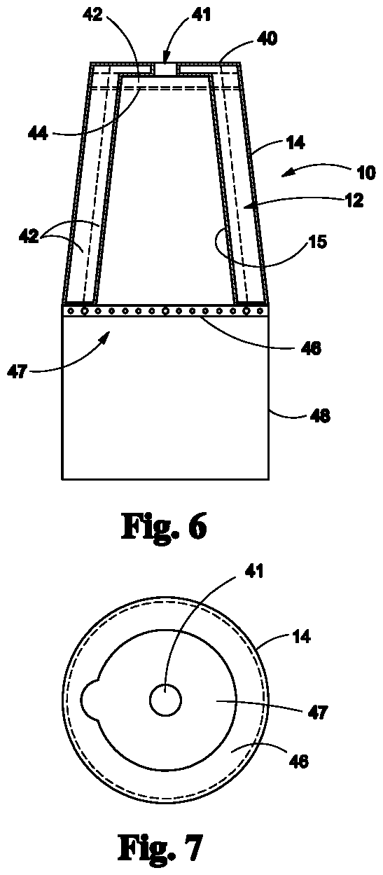

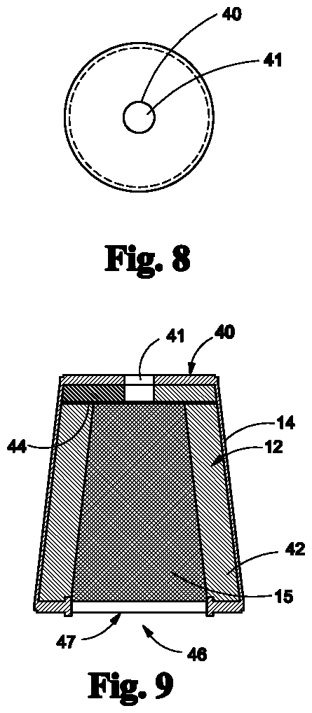

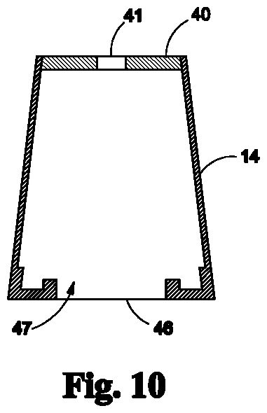

In a second embodiment shown at FIGS. 6-10, a solid cast shell 14 is employed, thereby eliminating the need for the first ring 50 and second ring 52.

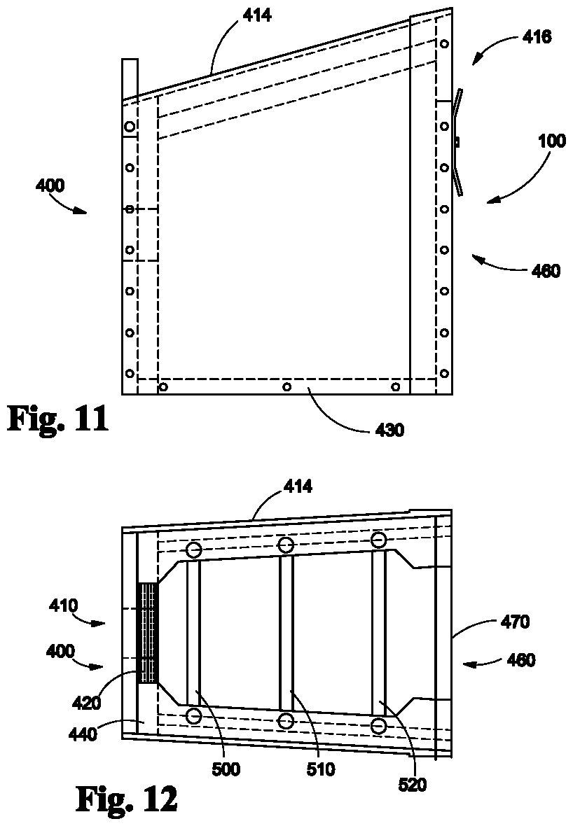

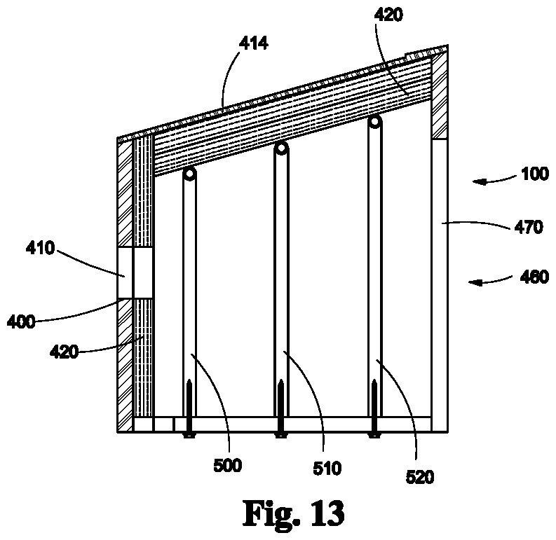

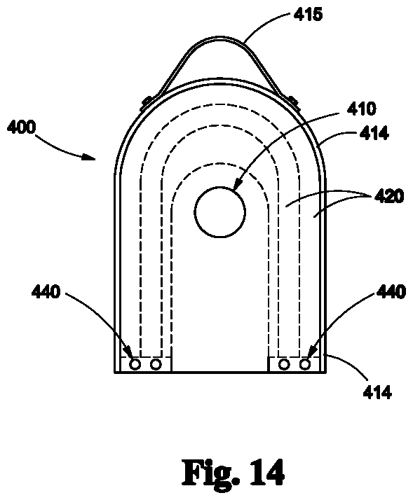

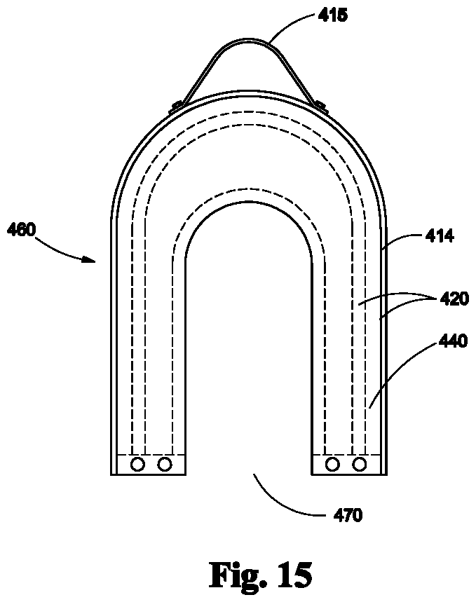

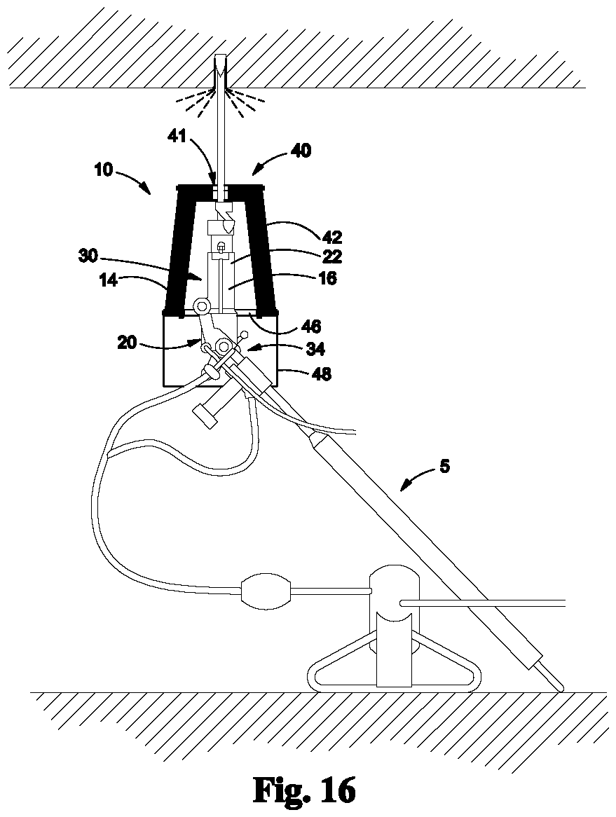

In a third embodiment as shown in FIGS. 11-15—noise suppression device 100 may be designed for horizontal drilling and may comprise arched ribs 500-520 a first arched rib 500 at a first end 400 forming a first opening 410, and a second arched rib 520 at a second and opening 470 at a second end 460 with additional arched ribs similarly oriented therebetween wherein at least one of a sound suppressor 420 and a liner 440 (together, sound dampening materials 12) extend over or under the ribs 500-520, the whole optionally covered by an arched shell 414 wherein a cross-section of the device resembles a semicircular or U-shape increasing in size between the first end 400 and the second end 460, see FIG. 9. In the second embodiment, the at least one of a sound suppressor (acoustic panel) 420 and liner 440 extend to cover the ribs 500-520 (either on the convex side or concave side of the ribs) to form an arch shape, but do not surround the ribs 500-520 in a manner that forms a tube-like structure. The covered (or lined) arch aspect allows the device 100 to be made with less material and comprise less weight while shielding/redirecting noise from the noise source 16 downward and away from the operator. Further, the covered arch shape allows the device 100 to be placed on and stably supported by a horizontal surface for use in horizontal drilling applications. Alternatively, the sound suppressor 420 and liner 440 may extend to cover the ribs 500-520 in a manner that forms a tube-like structure into which the body 22 of a horizontal drilling tool could be inserted. The second embodiment (in tube-like structure or non-tube-like structure) may, optionally, also include a skirt or skirting 480. The skirting 480 is associated with the second end 460 and directs noise away from the drill operator.

In an embodiment, the skirt or skirting 48 comprises neoprene and may comprise a dimension generally equal to the second opening 47, 470. The skirting may be cone or funnel-like in shape, or may exhibit similar circumference or shape with the second end 46, 460. In an embodiment, shell 14, 414 comprises HDPE plastic or material of similar flexibility, strength, and durability which may include old filter casing material. Inner layer 44, 440 material may include rubber lining, Thinsulate®, or old filter casing material as echo absorber material thereby forming an acoustic panel 42, 420. The inventive device may be used for, at least, roof bolting and drilling. With minor adjustment the device may be employed in horizontal bolting and drilling operations, or employed for use with vertically operated jack hammers.

To use the noise suppressing device 10 in a vertical drilling operation, the drill rod 18 of a jack leg drill 5, e.g., (See FIG. 11) is inserted through the second opening 47 through the ring 52 in the second end 46 of the device 10 and there through such that at least a portion of the drill rod 18 extends through the first end 40 of device 10 and the first ring 50 and first opening 41. Upon proper positioning, the drill rod 18 preferably extends at least in part past the first end 40 to be used in a drilling operation while at least a portion and preferably most of the noise source 16 remains positioned between the first opening 41 and the second opening 47 of the noise suppressing device 10. At least one sound suppressor such as echo absorber 42 and/or one or more rubber or mesh liner 44 is positioned in the shell 14, thereby suppressing some of the noise produced by the noise source 16 while the jack leg drill 5 is in operation. In a preferred embodiment, neoprene skirting 48 extends past the second opening 47 thereby directing the remaining noise further from the operator before exiting, and reducing its negative effects.

There are two ways to install the noise suppressing device 100 in a horizontal drilling operation. The first includes securing or placing the noise suppressing device 100 on a generally horizontal surface thereafter inserting the drill rod 18 of a drill through the first arched rib 500 at the first end 400, and through the second arched rib 520 at the second end 460. Alternatively, the drill comprising a drill rod 18 could be positioned first, with the noise suppressing device 100 placed over the drill 5 thereafter and, optionally, secured there. The covered arch shape allows the device 100 to be placed on and stably supported by a horizontal surface for use in horizontal drilling applications. Other than these factors, the vertical and horizontal embodiments may share common features.

Testing of the inventive device 10 shows measurable reduction in dba exposure from 104 to 97 during roof bolting. Reduction in dba translates to more work time per worker before the sound limit is reached. Data below shows three sets of data. Data for employee numbers 1-8 reports noise exposure to these employees when using typical noise reduction equipment. Data for employee numbers 9-17 was collected from employees using a first version of the noise suppression device, while data for employee numbers 18-23 was collected from employees using a second version of the noise suppression device. Data in terms of dosimeter reading (dosage) and number of bolts worked is presented.

| | Dosim- | Em- | | | |
|---|---|---|---|---|---|
| Date | eter | ployee | Dose | Comments | |
| Oct. 15, 2018 | 103 | 1. | 211 | w/o noise reduction | |
| | | | | equipment 1/2 days | |
| Oct. 15, 2018 | 104 | 2. | 278 | w/o noise reduction | |
| | | | | equipment 1/2 days | |
| Oct. 16, 2018 | 103 | 3. | 74.35 | first model & restricted | |
| | | | | hours or bolts | |
| Oct. 16, 2018 | 102 | 4. | 115.4 | 42 | bolts |
| Oct. 17, 2018 | 101 | 5. | 119.7 | 22 bolts and rework-pulled | |
| | | | | due to dosage | |
| Oct. 17, 2018 | 103 | 6. | 104.7 | 22 bolts and rework-pulled | |
| | | | | due to dosage | |
| Oct. 22, 2018 | 101 | 7. | 85.55 | | |
| Oct. 22, 2018 | 103 | 8. | 121.4 | 28 bolts (8:00-12:40), | |
| | | | | drive haul truck | |
| Oct. 23, 2018 | PSC | 9. | 89.2 | 53 | bolts |
| Oct. 23, 2018 | 101 | 10. | 26.63 | 60 | bolts |
| Oct. 23, 2018 | PSC | 11. | 49.46 | 60 | bolts |
| Oct. 23, 2018 | 102 | 12. | 24.49 | 50+ | bolts |
| Oct. 26, 2018 | 101 | 13. | 71.58 | 29 | bolts |
| | | | | (12:22-5:25) | |
| Oct. 26, 2018 | 102 | 14. | 60.85 | 29 | bolts |
| | | | | (12:22-5:30) | |
| Oct. 26, 2018 | 103 | 15. | 72.0 | 29 | bolts |
| | | | | (12:22-5:30) | |
| Oct. 26, 2018 | 104 | 16. | 70.75 | 21 | bolts |
| | | | | (6:30-12:01) | |
| Oct. 28, 2018 | 102 | 17. | 56.34 | 60 | bolts |
| Oct. 29, 2018 | 102 | 18. | 91.0 | Started dosimeter @ | |
| | | | | 10:39; 42 bolts | |
| Oct. 30, 2018 | PSC | 19. | 63.71 | 77 | bolts |
| Oct. 30, 2018 | 102 | 20. | 102.0 | 77 | bolts |
| Oct. 30, 2018 | MSHA | 21. | 97.88 | 77 | BOLTS |
| Oct. 31, 2018 | 103 | 22. | 56.21 | 84 | bolts |
| Oct. 31, 2018 | 102 | 23. | 48.6 | Rework | |
| Oct. 31, 2018 | MSHA | 24. | 58.88 | 84 | bolts |

Specifically, the study showed that production measured in bolts drilled increased from 22 bolts on average up to 80 bolts, and resulted in a reduction in noise exposure from average in dba from 138 to 75 db. While the study is not statistically designed, the results point to the possibility of greatly increased productivity when the inventive noise suppression device is used.

While the effectiveness of the device 10 is increased by including all of the claimed features, there may be specific uses that may achieve adequate sound reduction with fewer sound suppressors, or without the skirting, or with other adjustments which are considered to be within the scope of this invention.

Although the present invention has been particularly described with reference to implementations discussed above, various changes, modifications and substitutes can be made. Accordingly, it will be appreciated that in numerous instances some features of the invention can be employed without a corresponding use of other features. Further, variations can be take the number and arrangement of components illustrated in the figures discussed above. The foregoing description of embodiments of the invention has been presented for the purposes of illustration and description. It is not intended to be exhaustive or to limit the invention to the precise from disclosed. Many modifications and variations are possible in light of this disclosure. It is intended that the scope of the invention be limited not by this detailed description, but rather by the claims appended hereto.

1. A removable noise suppression device for reducing the rate of noise exposure to the user of a hand operated tool, said tool having a noise source, said noise suppression device comprising an inner surface sized and shaped to cover at least a portion of a body of the tool that embodies the noise source, said noise suppression device including a first open end, a second open end, at least one and preferably more than one sound suppressors comprising one or more of an acoustic panel and an echo absorber, at least one liner comprising noise reducing material generally extending between the first open end and the second open end, and a skirt opening away from the second open end.

2. The device of claim 1, said first open end having a first opening, said second open end having a second opening, said first opening smaller than said second opening, said at least one sound suppressor comprising at least one of rubber and mesh.

3. The removable noise suppression device of claim 2 further comprising a shell extending between the first opening and the second opening said shell at least partially covering said at least one sound suppressor.

4. The noise suppressing device of claim 2 further comprising a shell, a first ring at the first end sized to support the first opening, and a second ring at the second end sized to support the second opening, said shell extending between the first ring and the second ring thereby providing a generally conical structure and substantially surrounding said at least one sound suppressor.

5. The noise suppressing device of claim 4 wherein said at least one sound suppressor comprises a generally conical structure sized to fit within and abut generally contiguously with an internal surface of the shell.

6. The noise suppressing device of claim 5 wherein said skirt is associated with the second opening.

7. A noise suppressing device for use with hand-operated machinery said machinery comprising a noise source, said noise suppressing device comprising a first end and a second end, an inner surface comprising a conical shape, and a sound absorbing panel positioned inside and substantially contiguous to the inner surface.

8. The device of claim 7 further comprising at least one liner positioned between the first end and the second end and substantially contiguous to the sound absorbing panel, said inner surface sized to at least partially surround the noise source.

9. The device of claim 3 wherein said hand operated machinery comprises one of a hand-operated drilling machine and hammering machine.

10. The device of claim 1 wherein said inner surface shape is generally a “U” sized to be inverted over the noise source of the hand operated tool.

11. The device of claim 3 wherein said inner surface shape is generally cylindrical and sized to accept insertion of a portion of the hand operated tool comprising the noise source.

12. The device of claim 3, said hand operated drilling machinery further comprising a drilling rod wherein the outer shape of the noise suppressing device is generally a conical shape and sized to accommodate insertion of at least a portion of the noise source of the hand operated drilling machinery, wherein at least a portion of said drilling rod extends beyond said the outer shape of the noise suppressing device.

13. The device of claim 3 wherein said noise source comprises a motor.

14. The device of claim 3 wherein the hand-operated drilling machinery is a jack leg drill.

15. The device of claim 1 wherein the liner is comprised of one of rubber or wire mesh.

16. The device of claim 1 wherein said hand operated, motorized tool comprises a motor and a drill rod, said device further comprising a first ring at the first end forming the first opening, and a second ring at the second end forming the second opening.

17. A noise suppressing device for use with hand-operated drilling machinery comprising an outer shell, at least one of an acoustic panel and a mesh lining positioned between a first ring near a first end forming a first opening and a second ring near a second end forming a second opening, said at least one of an acoustic panel and a mesh lining substantially covering an inner surface of the outer shell.

18. The device of claim 17 further comprising a neoprene skirting extending past the second opening thereby directing noise further from an operator before exiting the second opening.
